(19) United States
(12) Patent Application Publication
(10) Pub. No.: US 2005/0097028 A1
(43) Pub. Date: May 5, 2005

(54) Method and system for predicting attrition customers

(76) Inventors: Larry Watanabe, Princeton, NJ (US); Patrick Yip, Morristown, NJ (US); Praveen Reddy, Jersey City, NJ (US)

Correspondence Address: MCDERMOTT, WILL & EMERY, 600 13th Street, N.W., Washington, DC, 20005-3096, US

(21) Appl. No.: 10/851,646

(22) Filed: May 24, 2004

Related U.S. Application Data
(60) Provisional application No. 60/472,422, filed on May 22, 2003.
(60) Provisional application No. 60/472,412, filed on May 22, 2003.
(60) Provisional application No. 60/472,748, filed on May 23, 2003.
(60) Provisional application No. 60/472,747, filed on May 23, 2003.

(51) Int. Cl. G06F 17/60

(52) U.S. Cl. 705/37

(57) ABSTRACT

A method and system predict customers/accounts that are likely to become attrited based on predefined classification rules and customer data/account information associated with the customers/accounts. The classification rules are generated by parsing through historical customer data/account information to identify attrition customers/accounts and their associated attributes. Unique algorithm is used to determine attrition statuses of the customers or accounts. After the classification rules are generated, the rules are applied to new customer data or account information to predict customers or accounts that are likely to become attrited.

### RELATED APPLICATIONS

This application claims the benefit of priority from the following U.S. Provisional Patent Applications: U.S. Provisional Patent Application Ser. No. 60/472,422, titled “CUSTOMER SCORING MODEL,” filed May 22, 2003, U.S. Provisional Patent Application Ser. No. 60/472,412, titled “LIFETIME REVENUE MODEL,” filed May 22, 2003; U.S. Provisional Patent Application Ser. No. 60/472,748, titled “FINANCE DATA MART ACCOUNT PROFITABILITY MODEL,” filed May 23, 2003; and U.S. Provisional Patent Application Ser. No. 60/472,747, titled “RATE INFORMATION MART ATTRITION ANALYSIS MODEL,” filed on May 23, 2003; and is related to U.S. patent application Ser. No. ______ (attorney docket 67389-037), titled “RATING SYSTEM AND METHOD FOR IDENTIFYING DESIRABLE CUSTOMERS,” filed concurrently herewith; U.S. patent application Ser. No. ______ (attorney docket 67389-038), titled “CUSTOMER REVENUE PREDICTION METHOD AND SYSTEM,” filed concurrently herewith; and U.S. patent application Ser. No. ______ (attorney docket 67389-039), titled “ACTIVITY-DRIVEN, CUSTOMER PROFITABILITY CALCULATION SYSTEM,” filed concurrently herewith. Disclosures of the above-identified patent applications are incorporated herein by reference in their entireties.

### FIELD OF DISCLOSURE

This disclosure generally relates to a method and system for predicting accounts or customers that will become attrited in the future, and more specifically, to a prediction method and system that generate classification rules based on historical account information or customer data, and apply the classification rules to predict whether an account or a customer will become attrited in a selected time period in the future.

### BACKGROUND OF THE DISCLOSURE

An attrition customer or account is a customer or account of a company or organization that has become attrited, i.e., inactive or involved in insubstantial or limited activities during a predefined period of time. For instance, if an account is inactive for the past three months, that account can be considered as an attrition account as of this month. Once a customer or account becomes attrited, the customer or account is effectively lost as a source of revenue for the company or organization. Therefore, it is very important for a company or organization to be able to predict which of its customers or accounts will become attrition customers/accounts shortly, for example, so that the company or organization can take action targeting these accounts/customers, such as providing special benefits or discounts, renewed promotions, telephone calls, etc., to keep these accounts/customers.

Therefore, there is a need for a system or technique to predict whether a customer or account is becoming attrited soon. There is another need to determine whether an attrition account or customer is a desirable account/customer, such as those that generate significant profits to the company, such that the company can focus its efforts to retain these profitable customers or accounts. There is also a need to generate appropriate classification rules for applying to existing customers or accounts to identify attrition accounts/customers.

### SUMMARY OF THE DISCLOSURE

This disclosure presents a method and system for predicting customers/accounts that are likely to become attrited based on predefined classification rules and customer data/account information associated with the customers/accounts. The classification rules are generated by parsing through historical customer data/account information to identify attrition customers/accounts and their associated attributes. Unique algorithms are used to determine attrition statuses of the customers or accounts. After the classification rules are generated, the rules are applied to new customer data or account information to predict customers or accounts that are likely to become attrited.

An exemplary method for predicting attrition accounts uses a unique training process to generate a classifier, such as classification rules or decision trees, for use to predict which accounts are likely to come attrited based on their respective account information. During the training process, a target time period is identified, and an attrition status of each of a first plurality of accounts within a known account pool in connection with the target time period is determined. The attrition status is determined based on predetermined definitions of attrition. A base training time period prior to the target time period is also selected. Account information for each of the accounts during the base training time period is retrieved. The determined attrition status for each account and their respective account information form the base training period is input to a decision tree generator as a set of training examples. Based on these training examples, the decision tree generator produces a decision tree classifier that classifies unseen examples relative to their respective attrition status based on their respective account information.

In one embodiment, the method identifies a prediction time period for identifying accounts that are likely to become attrited during the prediction time period. A base time period prior to the prediction time period is identified, and account information associated therewith is retrieved. The decision tree classifier then classifies the accounts based on their respective account information associated with the base time period. According to another embodiment, during the training process, a number of different base training time precede the target time period by a predetermined time period, such as one, two or three months, are identified, and corresponding account information are retrieved. The training process is repeated using the account information to allow the decision tree generator to produce decision trees that predict the attrition status for accounts one, two or three months in the future, respectively.

According to another embodiment, an exemplary prediction method further accesses profitability data of each account and determines the profitability status of each account by comparing the profitability data with a profitability threshold. The profitability status can be then used as the target classification. The same method used for attrition status training can be used to generate one, two and three-month decision trees for predicting customer profitability.

A data processing system, such as a computer, may be used to implement the method and system as described herein. The data processing system may include a processor for processing data and a data storage device coupled to the processor, and a data transmission interface. The data storage device bears instructions to cause the data processing system upon execution of the instructions by the processor to perform functions as described herein. The instructions may be embedded in a machine-readable medium to control the data processing system to perform calculations and functions as described herein. The machine-readable medium may include any of a variety of storage media, examples of which include optical storage media, such as CD-ROM, DVD, etc., magnetic storage media including floppy disks or tapes, and/or solid state storage devices, such as memory card, flash ROM, etc. Such instructions may also be conveyed and transmitted using carrier wave type machine-readable media.

Still other advantages of the presently disclosed methods and systems will become readily apparent from the following detailed description, simply by way of illustration and not limitation. As will be realized, the activity driven, customer profitability calculation method and system are capable of other and different embodiments, and their several details are capable of modifications in various obvious respects, all without departing from the disclosure. Accordingly, the drawings and description are to be regarded as illustrative in nature, and not as restrictive.

### BRIEF DESCRIPTIONS OF THE DRAWINGS

The accompanying drawings, which are incorporated in and constitute a part of the specification, illustrate exemplary embodiments.

FIG. 1 is a schematic functional block diagram illustrating the operation of an exemplary system 100 for predicting an attrition account.

FIG. 2 shows an exemplary training process for generating decision tree.

FIGS. 3a and 3b are flow charts showing examples for generating training data for use by decision tree generator as shown in FIG. 2.

FIG. 4 depicts a flow chart illustrating an exemplary process for predicting an attrition status for an account.

FIG. 5 shows a schematic block diagram of a data processing system upon which an exemplary system for predicting attrition customers may be implemented.

### DETAILED DESCRIPTIONS OF ILLUSTRATIVE EMBODIMENTS

In the following description, for the purposes of explanation, numerous specific details are set forth in order to provide a thorough understanding of the present subject matter. It will be apparent, however, to one skilled in the art that the present method and system may be practiced without these specific details. In other instances, well-known structures and devices are shown in block diagram form and described in summary functional terms in order to avoid unnecessarily obscuring the present disclosure.

For illustration purposes, the following descriptions discuss an exemplary method and system for use in a brokerage firm to identify customers/accounts that are likely to become attrited soon. It is understood that a customer may be associated with one or more accounts set up with the brokerage firm. When a customer has only one account, the term “account” and “customer” may be used interchangeably. It is also understood that the method and system disclosed herein may apply to many other types of industries or companies, and may have different variations, which are covered by the scope of this application.

The following terms may be used throughout the descriptions presented herein and should generally be given the following meanings unless contradicted or elaborated upon by other descriptions set forth herein.

Active Customer/Account: an account or customer that has been active or involved in substantial activities during a defined time period. Predefined conditions can be used to determine whether an account or customer is active or not.

Attrition Customer/Account: an account or customer that has been inactive or involved in limited or insubstantial activities during a defined time period. Predefined conditions can be used to determine whether an account or customer is attrited or not. Usually, an attrition customer/account is defined as a non-active customer/account. Conversely, an active customer/account is defined as a non-attrition customer/account.

Account Information: information related to an account including, but not limited to, account identification, account owner, activity history, profitability status, revenue generated by, or associated with, the account, assets level associated with the account, demographic information of the owner, etc.

Attrition Month: the last month that an attrition customer or account qualifies as an active customer or account.

Base Time Period: a selected time period, such as three months, for which customer data or account information is retrieved for use with classification rules to predict attrition customers/accounts in a prediction time period.

Base Training Time Period: a selected time period, such as three months, for which known customer data or account information is retrieved to feed to a decision tree generator during a training process to generate classification rules to identify attrition customers/accounts.

Customer Data: information related to a customer including, but not limited to, information of one or more accounts associated with the customer, customer identification, activity history, profitability status of the customer, revenue generated by, or associated with, the customer, assets level associated with the customer, demographic information of the customer, etc. Customer data for a specific customer may link or refer to the account information of one or more accounts owned by the specific customer.

Prediction time period: a specific time period, such as a number of months after the base time period, for determining whether a customer or account would become attrited during that time period.

Profitability Data: data indicating a profitability status, i.e., a loss or a profit and their corresponding amounts, corresponding to a customer or account.

Target Time Period: a specific time period for which an attrition status of each customer or account is determined, in order to feed the attrition status of the account or customer to a decision tree generator during a training process to generate classification rules to identify attrition customers/accounts.

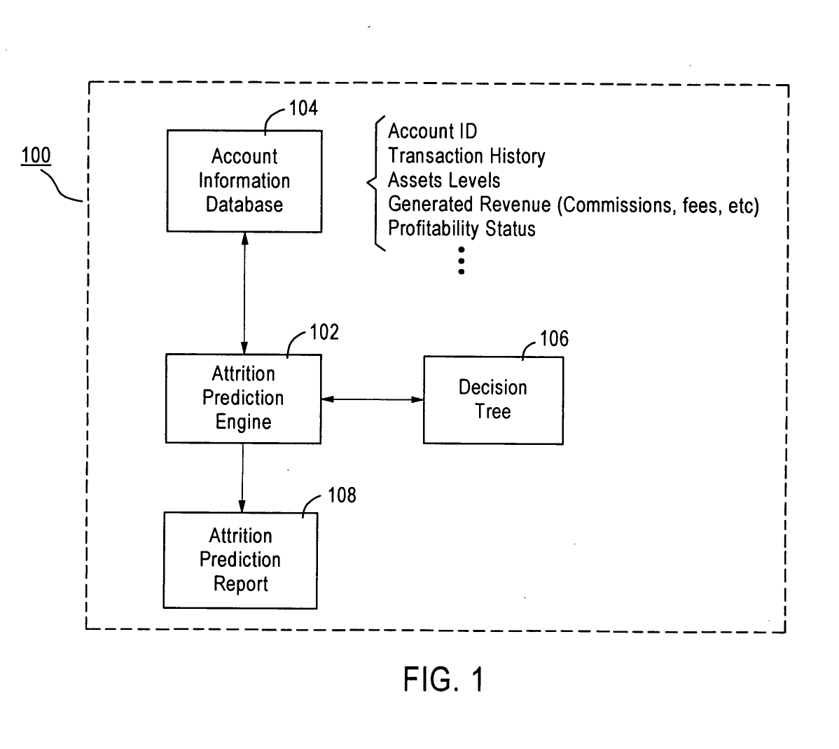

An exemplary method and system for predicting attrition customers/accounts provides a unique training process using known customer data or account information to generate classification rules that are used to predict customers or accounts that are likely to become attrited. The training process parses through historical customer data/account information to identify attrition customers/accounts and their associated attributes, and generates the classification rules, such as a decision tree for use in an expert system, for use in predicting attrition customers/accounts in an existing customer/account pool based on their respective customer data/account information. FIG. 1 is a schematic functional block diagram illustrating the operation of an exemplary system 100 for predicting an attrition account. System 100 includes an attrition prediction engine 102 having access to an account information database 104 and a decision tree 106. Account information database 102 stores various types of data related to a plurality of accounts. The information may include, but is not limited to, account IDs, identification of account owner, demographic information of the owner, assets levels, activity histories, revenue data, profitability status, and transaction histories, etc. Account information database 104 provides a data field for storing profitability data to indicate profitability status of each account, such as a profit or a loss and their respective amounts, reflecting expenses and incomes generated by the account during a specific period of time, such as a month, a quarter or since the account was opened to date. Detailed descriptions of determining and updating the profitability status and revenue data are discussed in U.S. patent application Ser. No. ______ (attorney docket 67389-038), titled “CUSTOMER REVENUE PREDICTION METHOD AND SYSTEM,”; and U.S. patent application Ser. No. ______ (attorney docket 67389-039), titled “ACTIVITY-DRIVEN, CUSTOMER PROFITABILITY CALCULATION SYSTEM,” both of which are filed concurrently herewith and incorporated herein by reference.

Decision tree 106 is a set of classification rules or algorithm used by attrition prediction engine 102 to parse through the account information of existing accounts to generate an attrition prediction report 108 predicting which accounts will become attrited or remain active in a specific time period (detailed process for generating the decision tree will be discussed shortly). Decision tree 106 may be generated by system 100 or conveyed by other data processing systems before system 100 starts to perform predictions on accounts or customers. Attrition prediction report 108 may be implemented in a machine-readable format to be accessed by other data processing systems.

System 100 may be implemented on one or more data processing systems, such as a single computer, or a distributed computing system including a plurality of computers with network connections. Account information database 104 and decision tree 106 may be stored in the data storage device in the same data processing system and/or any other data storage devices accessible by the data processing system, and may be transferred via a carrier through network communication.

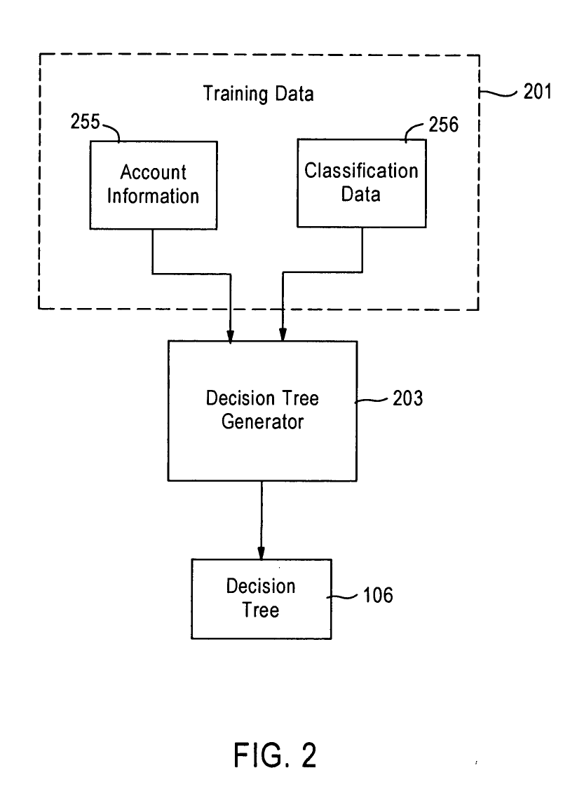

As discussed earlier, decision tree 106 is generated based on historical account information. FIG. 2 illustrates an exemplary process for generating decision tree 106. A decision tree generator 203 is used for generating decision tree 106 based on training data 201. Training data 201 includes two types of data: known account information 255 and classification data 256. Classification data 256 includes classification results of existing accounts established by parsing through known account information 255 to classify the accounts associated with account information 255 into active accounts and attrition accounts. Based on the classifications of the accounts and their respective account information, decision tree generator 203 generates decision tree 106 for use in system 100.

Decision tree generator 203 is an automatic tool that inputs raw data and classification results thereof, and generates classification rules for classifying future raw data. Data mining tools, such as a free software application, C4.5 by Ross Quinlan, and one or more data processing systems, such as one or more computers, may be used to implement decision tree generator 203. C4.5 is a program for deriving classification rules in the form of decision trees from a set of given examples. The decision tree can be used to classify new, unseen examples of the class as positive or negative, and to predict outcomes for future situations as an aid to future decision-making.

In operation, existing account information is parsed and classified into two groups of accounts: attrition accounts and active accounts (detailed process for classifications will be discussed shortly), and the results are fed into decision tree generator 203. A data field in the account information of each account, such as attrition_status, may be used to indicate whether an account is active or attrited. If an account is active, the corresponding attrition_status may be identified as 0; and if an account is attrited, the corresponding attrition_status may be identified as 1. Account information 255 associated with each account is also fed into decision tree generator 203. Account information 255 may include, but is not limited to, number of trades, profitability status, revenue generated by the account, assets level associated with the account, demographic data of the owner, transaction history, etc. The assets level of an account is defined as the sum of all assets (whenever the data is available) associated with the account. In the brokerage example, possible assets that may be associated with an account include, but are not limited to, common equity, preferred stock, rights/warrants, units, options, corporate debts, CMO/MBS/ABS, Money market, municipal bonds, US government/Agency bonds, mutual funds, mutual funds with load, UIT and/or any other types of instruments or assets that be associated with an account.

Demographic data is defined as information in connection with attributes and/or characteristics related to the owner of an account or may be used to identify the owner of an account. For instance, demographic data may include, but is not limited to, duration with the brokerage firm, city size, age, gender, education, marital status, income, address, status of house ownership, number and/or types of owned vehicles, household income, number of family members, number of children, ages of children, frequency of dining out, hobbies, etc. The list does not mean to be exhaustive.

Data related to transaction history is defined as every type of information that relates to any transactions that a user has conducted in the past. Transaction history data may include dates of transactions, types of transactions, amount of transactions, frequency of transactions, average amount of transactions, monthly number of trades, average trades per month, total trades within a specific period of time, numbers of shares per transaction, 12-month moving average of total trades per month, etc. The transaction history data could also include actual income or profit data or metrics derived from income or profit, e.g. dollar of brokerage commissions, or actual or average percentage commissions.

Other types of account information also may be included. For instance, for a brokerage firm, the following types of account information may also be used: average long market value for last three months, average short market value for last three months, average total assets for last three months, average total assets for last three months, average total assets for last 12 months, commissions for last three months, interest and other fee for last three months, number of trades in last three months, fund deposit in last three months, fund withdrawal in last three months, number of account types, and/or deposit delay days, etc.

In addition to the different types of account information that may be input to decision tree generator 203, different account information and classification results during various time periods can be input to decision tree generator 203 for the purpose of generating decision tree 106. For instance, the same set of account information during a specific time period (such as account information from April 2002 through July 2002) and several sets of classification results for different time periods (such as attrition statuses for the same account for October, November and December 2002) may be input to decision tree generator 203 to generate one or more decision trees 106 for predicting an attrition status of an account for three different months based on account information for a three-month period of time.

After the training process, decision tree generator 203 generates decision tree 106, which may be in a form of an algorithm to classify incoming accounts based on their respective account information, such as number of trades, profitability status, revenue generated by the account, assets level associated with the account, demographic information of the owner, etc. Decision tree 106 is then used by system 100 to apply to account information input to attrition prediction engine 102 to predict an attrition status in the future for an account corresponding to the input account information.

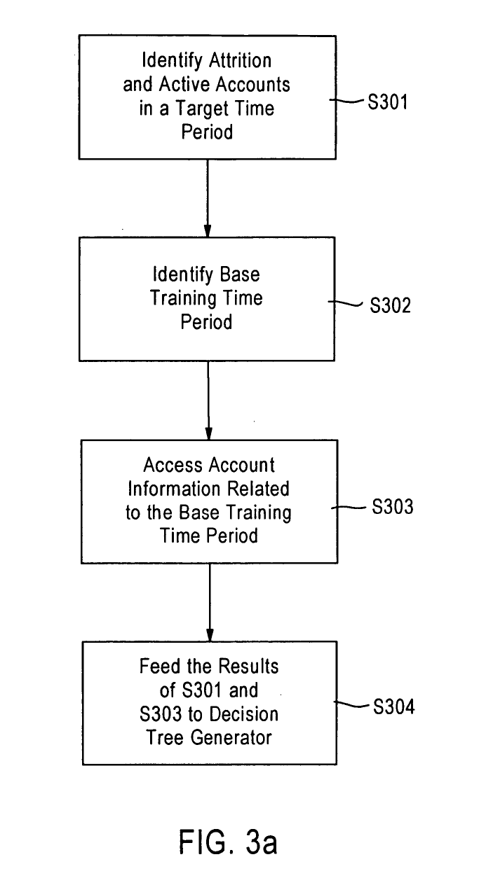

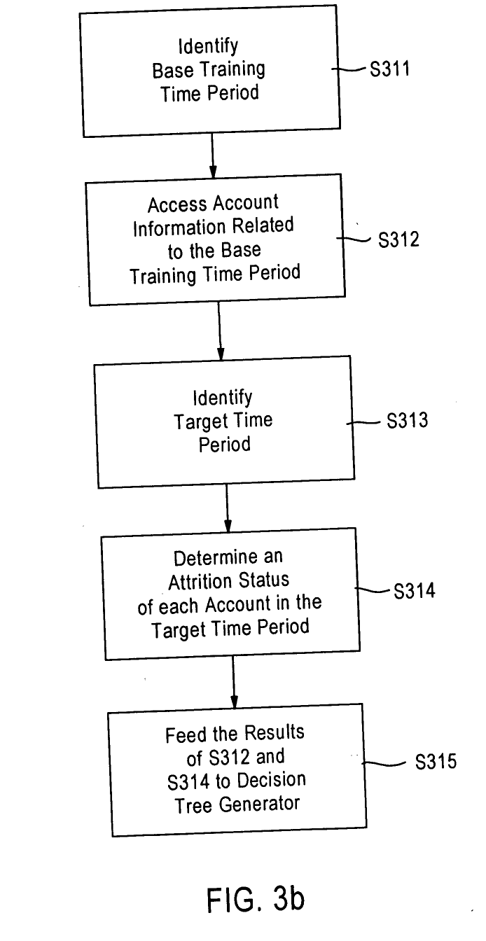

FIG. 3a is a flow chart showing an exemplary process for generating training data 201 for use by decision tree generator 203 as shown in FIG. 2. In Step S301, attrition accounts and active accounts are identified from an existing account pool. In order to determine whether an account is active or attrited, predefined conditions for active accounts or attrition accounts are used. For example, in order to determine whether an account in an existing account pool is an active account or an attrition account, the following definitions and conditions are used:
Entire Account Pool=Active Accounts+Attrition Accounts; and
an account is an attrition account as of a selected target time period, such as this month, if the account satisfies the following conditions:
1 . total assets<=USD 120 in each of the last three months;
AND 2. trade number<=0 in each of the last three months;
AND 3. commission<=USD 0 in each of the last three months;
OR 4. Total assets<=USD 0.0 in the last month;
   and an active account is an account that is not an attrition account.
      Although the above definitions utilize total assets, trade numbers and commission to define attrition or active accounts, it is understood that the above definitions are for illustration purpose only. Other values and/or different types of account information may be used to define attrition accounts and/or active accounts. Thus, in step S301, system 100 parses through the account pool identifying accounts satisfying conditions 1-4 as attrition accounts, and accounts not satisfying conditions 1-4 as active accounts.

In Step S302, a base training time period is identified or selected to provide a time range, such as three months, for system 100 to retrieve account information, such as number of trades, profitability status, revenue generated by the account, assets level associated with the account, demographic information of the owner, etc., within the base training time period to feed to decision tree generator 203 as shown in FIG. 2. In this example, the base training time period is set as the past three months. Other base time periods can also be used. After the base training time period is selected or retrieved, account information, such as number of trades, profitability status, revenue generated by the account, assets level associated with the account, demographic information of the owner, etc., is retrieved (Step S303) and fed into decision tree generator 203, as described relative to FIG. 2 (Step S5304).

According to one embodiment, a modified process for preparing training data 201 is provided. The modified process is substantially similar to that discussed above relative to FIG. 3a, except for the step of S302. In the example above, once the attrition status as of a target time period (such as today) is determined, the base training time period is set as the past three months (relative to today). In the modified process, the base training time period for active accounts remains the same (i.e., the past three months), but the base training time period for attrition accounts is not set as relative to the target time period for which an attrition status of the attrition account is determined. Rather, the base time period is set as a predetermined time period before the attrition account becomes attrited. For example, an account that is determined as an attrition account as of today may have been attrited years ago. Thus, inaccuracy may occur to the training data if the information for that attrition account during the past three months is used to train decision tree generator 203. In order to address this concern, for each attrition account, the modified process identifies the last day that the account remains active, or the first day that the account becomes attrited. The base time period for the attrition accounts in this example is set as three month before the last day that the account remains active, or the first day that the account becomes attrited. This modified process ensures that the account information for the attrition accounts fed to decision tree generator 203 to be closely related to the account behaviors before it comes attrited, such that a more accurate training process can be performed.

Another embodiment for preparing training data 201 is illustrated in FIG. 3b. In Step 311, an arbitrary or predefined base training time period is identified. For instance, the base training time period can be selected as between March 2003 through May 2003, and the respective account information including number of trades, profitability status, revenue generated by the account, assets level associated with the account, demographic information of the owner, etc., during the base training period is retrieved (Step S312). In Step S313, a predefined or arbitrary target time period that is after the base time period identified in Step S311 is selected or retrieved. For example, the target time period may be set as June 2003, or any time after May 2003. In Step S314, an attrition status of each account in the target time period is determined. In Step S315, the attrition status of each account and their respective account information are fed to decision tree generator 203 as discussed earlier, in order to train decision tree generator 203 to generate a decision tree 106.

As discussed earlier, during the training process, the same set of account information during a specific time period (such as account information from April 2002 through July 2002) and several sets of classification results for different time periods (such as attrition statuses for the same account for October, November and December 2002) may be input to decision tree generator 203 to generate one or more decision trees 106 for predicting an attrition status of an account for three different months based on account information for a three-month period of time.

After the training process as discussed above, a decision tree 106 is generated. System 100 utilizes decision tree 106 to predict an attrition status of an account. Continuing to the definitions of attrition and active accounts used above, because the definitions use account attributes from the past 3 months as part of the definitions, the attrition status for the next month may already have been fully determined by past activities. For example, if an account executes a trade this month, then it is already known that the account would not be defined as an attrition account in the next two months. If it is known that an account has conducted certain activities in July, system 100 is able to determine the attrition status of that account for the next two months (August and September) as non-attrited. Thus, with the latest known activity in a base month related to an account, system 100 is able to predict the attrition status of the account for the prediction month=base month+k+2, where k=1 for the 1-month prediction, 2 for the 2-month prediction, and 3 for the 3-month predictions, based on account information from April through July. Thus, based on different definitions used to define attrition accounts, effective predictions of attrition status may be extended.

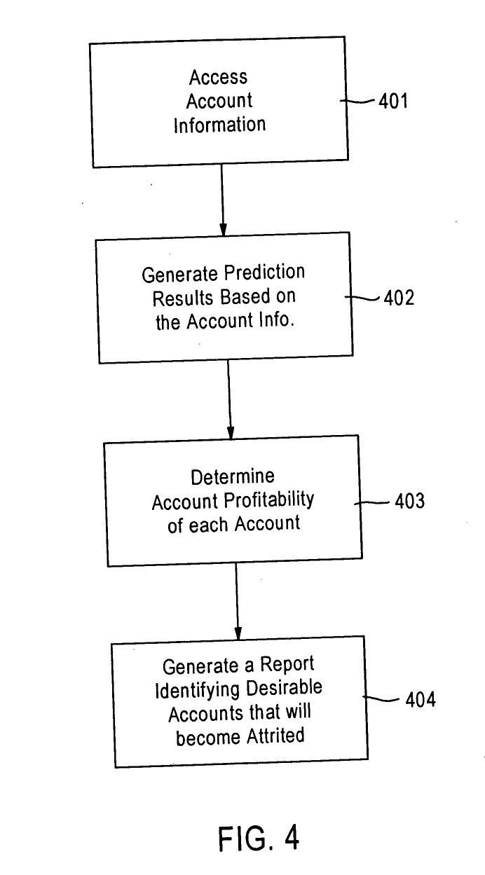

FIG. 4 depicts a flow chart illustrating an exemplary process for predicting an attrition status for an account. In Step 401, attrition prediction engine 102 accesses account information for accounts on which predictions are to be performed. In Step 402, attrition prediction engine 102 accesses decision tree 106 and applies the account information obtained in Step 401 to decision tree 106 to generate predictions for attrition statuses of the accounts. Attrition prediction engine 102 may further access a profitability status of each account from account information database 104 in order to identify accounts that are desirable to the brokerage firm but will become attrited soon (Step 403). The desirability of an account may be determined by comparing the profitability status of a predefined threshold. For instance, an account may be determined as desirable if it generates monthly profits more than fifty dollars to the brokerage firm. A report including such information may be generated (Step 404) such that the brokerage firm may take appropriate approach to keep the desirable accounts, such as by providing discounts, additional services, making phone calls, etc.

Although the above examples are related to predicting attrition accounts, it is understood that the same system and method describe herein can also be used to determine an attrition status for a customer with only minor modifications. Since a customer may have one or more accounts with the brokerage firm, a preparation process can be performed to revise the system to perform predictions on customer levels rather than account levels. For instance, the preparation process may parse through the account information to identify accounts belong to the same customer, and aggregate the account information to be related to the customer. Same definitions for attrition and active accounts can be used to identify attrition and active customers based on activities related to one or more accounts associated with each customer. The same determinations and processes used in generating decision 106 for accounts can be used for training decision tree generator 203 to generate decision 106 predicting attrition statuses at customer levels.

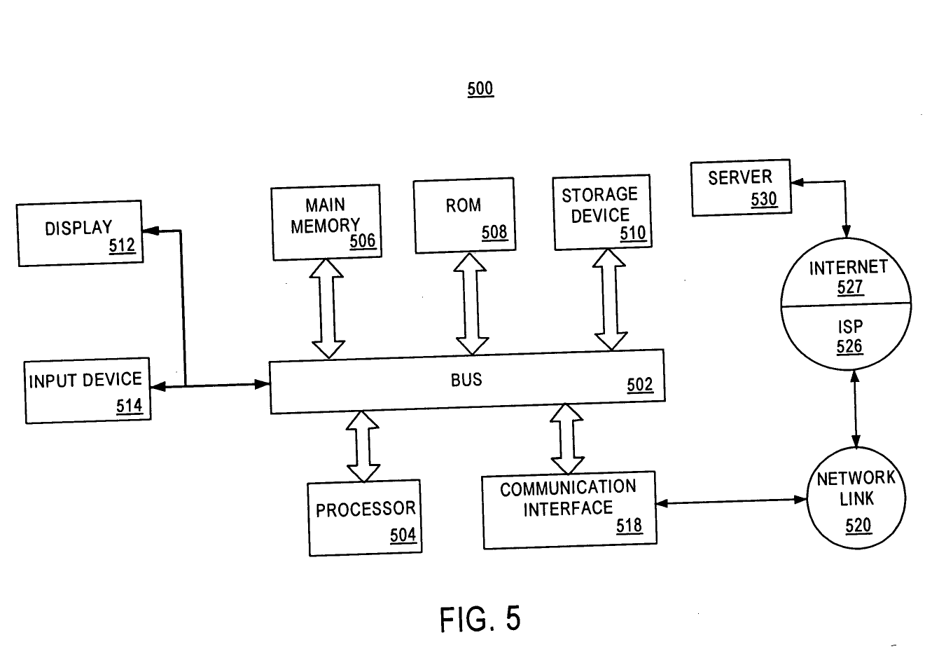

FIG. 5 shows a block diagram of an exemplary data processing system 500 upon which the activity driven, customer profitability calculation system 100 may be implemented. As discussed earlier, system 100-may be implemented with a single data processing system 500 or a first plurality of data processing systems 500 connected by data transmission networks. The data processing system 500 includes a bus 502 or other communication mechanism for communicating information, and a data processor 504 coupled with bus 502 for processing data. The data processing system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by data processor 504. Data processing system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

The data processing system 500 may also have suitable software and/or hardware for converting data from one format to another. An example of this conversion operation is converting format of data available on the system 500 to another format, such as a format for facilitating transmission of the data. The data processing system 500 may be coupled via bus 502 to a display 512, such as a cathode ray tube (CRT), plasma display panel or liquid crystal display (LCD), for displaying information to an operator. An input device 514, including alphanumeric and other keys, is coupled to bus 502 for communicating information and command selections to processor 504. Another type of user input device is cursor control (not shown), such as a mouse, a touch pad, a trackball, or cursor direction keys and the like for communicating direction information and command selections to processor 504 and for controlling cursor movement on display 512.

The data processing system 500 is controlled in response to processor 504 executing one or more sequences of one or more instructions contained in main memory 506. Such instructions may be read into main memory 506 from another machine-readable medium, such as storage device 510 or carrier received via communication interface 518. Execution of the sequences of instructions contained in main memory 506 causes processor 504 to perform the process steps described herein.

In one embodiment, profitability calculation engine 102 of the activity-driven, customer profitability calculation system 100 is implemented by processor 504 under the control of suitable instructions stored in storage device 510. For instance, under the control of pre-stored instructions, the data processor 504 accesses account information data and decision tree stored in the data storage device 510 and/or other data storage device coupled to the data processing system, and performs predictions of attrition statuses. In alternative embodiments, hard-wired circuitry may be used in place of or in combination with software instructions to implement the disclosed calculations. Thus, the embodiments disclosed herein are not limited to any specific combination of hardware circuitry and software.

The term “machine readable medium” as used herein refers to any medium that participates in providing instructions to processor 504 for execution or providing data to the processor 504 for processing. Such a medium may take many forms, including but not limited to, non-volatile media, volatile media, and transmission media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502 or an external network. Transmission media can also take the form of acoustic or light waves, such as those generated during radio wave and infrared data communications, which may be carried on the links of the bus or external network.

Common forms of machine readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a data processing system can read.

Various forms of machine-readable media may be involved in carrying one or more sequences of one or more instructions to processor 504 for execution. For example, the instructions may initially be carried on a magnetic disk of a remote data processing system, such as a server. The remote data processing system can load the instructions into its dynamic memory and send the instructions over a telephone line using a modem. A modem local to data processing system 500 can receive the data on the telephone line and use an infrared transmitter to convert the data to an infrared signal. An infrared detector can receive the data carried in the infrared signal, and appropriate circuitry can place the data on bus 502. Of course, a variety of broadband communication techniques/equipment may be used for any of those links. Bus 502 carries the data to main memory 506, from which processor 504 retrieves and executes instructions and/or processes data. The instructions and/or data received by main memory 506 may optionally be stored on storage device 510 either before or after execution or other handling by the processor 504.

Data processing system 500 also includes a communication interface 518 coupled to bus 502. Communication interface 518 provides a two-way data communication coupling to a network link 520 that is connected to a local network. For example, communication interface 518 may be an integrated services digital network (ISDN) card or a modem to provide a data communication connection to a corresponding type of telephone line. As another example, communication interface 518 may be a wired or wireless local area network (LAN) card to provide a data communication connection to a compatible LAN. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network to data equipment operated by an Internet Service Provider (ISP) 526. ISP 526 in turn provides data communication services through the world wide packet data communication network now commonly referred to as the Internet 527. Local ISP network 526 and Internet 527 both use electrical, electromagnetic or optical signals that carry digital data streams. The signals through the various networks and the signals on network link 520 and through communication interface 518, which carry the digital data to and from data processing system 500, are exemplary forms of carrier waves transporting the information.

The data processing system 500 can send messages and receive data, including program code, through the network(s), network link 520 and communication interface 518. In the Internet example, a server 530 might transmit a requested code for an application program through Internet 527, ISP 526, local network and communication interface 518. The program, for example, might implement generating decision trees and predicting attrition statuses. The communications capabilities also allow loading of relevant data into the system, for processing in accord with this disclosure.

The data processing system 500 also has various signal input/output ports for connecting to and communicating with peripheral devices, such as printers, displays, etc. The input/output ports may include USB port, PS/2 port, serial port, parallel port, IEEE-1394 port, infra red communication port, etc., and/or other proprietary ports. The data processing system 500 may communicate with other data processing systems via such signal input/output ports.

The system and method as discussed herein may be implemented using a single data processing system, such as a single PC, or a combination of a first plurality of data processing systems of different types. For instance, a client-server structure or distributed data processing architecture can be used to implement the system disclosed herein, in which a first plurality of data processing systems are coupled to a network for communicating with each other. Some of the data processing systems may serve as servers handling data flow, providing calculation services or access to customer data, and/or updating software residing on other data processing systems coupled to the network.

It is intended that all matter contained in the above description and shown in the accompanying drawings shall be interpreted as illustrative and not in a limiting sense. It is also to be understood that the following claims are intended to cover all generic and specific features herein described and all statements of the scope of the various inventive concepts which, as a matter of language, might be said to fall there-between.

1. A method for predicting attrition accounts comprising the steps of:
defining a base training time period;
accessing account information for each of a first plurality of accounts related to the base training time period;
identifying a target time period after the base training time period;
determining an attrition status of each of the first plurality of accounts in connection with the target time period;
classifying the first plurality of accounts based on the attrition status of each of the first plurality of accounts in connection with the target time period; and
generating a classification rule based on the account information for each of the first plurality of accounts related to the base training time period, and a result of the classifying step.

2. The method of claim 1 further comprising the steps of:
identifying a prediction time period;
identifying a base time period prior to the prediction time period;
accessing account information for each of the second plurality of accounts in connection with the base time period; and
classifying the second plurality of accounts by applying the classification rule to the accessed account information for each of the second plurality of accounts in connection with the base time period.

3. The method of claim 2 further comprising a step of generating an attrition prediction report based on a result of the classifying step, wherein the report includes a prediction of an attrition status for each of the second plurality of accounts.

4. The method of claim 3 further comprising a step of generating a warning message for at least one of the second plurality of accounts that has a predicted attrition status indicating that the account will become an attrition account in the prediction time period.

5. The method of claim 3 further comprising the steps of:
accessing profitability data of each of the second plurality of accounts or each of the at least one account that will become an attrition account;
comparing the profitability data of each of the second plurality of accounts or each of the at least one account that will become an attrition account with a predetermined profitability threshold; and
generating a profitability status for each of the second plurality of accounts or each of the at least one account that will become an attrition account, based on a result of the comparing step.

6. The method of claim 5 further comprising a step of classifying the second plurality of accounts based on the predicted attrition status and the profitability status of each of the second plurality of accounts.

7. The method of claim 6 further comprising a step of identifying at least one account that both has a predicted attrition status indicating that the account will become an attrition account in the prediction time period, and a profitability status exceeding the predetermined profitability threshold.

8. The method of claim 2, wherein the length of the base training time period is substantially equal to the length of the base time period.

9. The method of 1, wherein the account information includes at least one of: total assets of the account, total trade number in connection with the account, and total revenue associated with the account.

10. The method of 2, wherein the account information for each of the second plurality of accounts in connection with the base time period includes at least one of: total assets of the account, total trade number in connection with the account, and total revenue associated with the account.

11. A method for predicting attrition customers comprising the steps of:
defining a base training time period;
accessing customer data for each of a first plurality of customers related to the base training time period, wherein the customer data includes account information of one or more accounts associated with each of the first plurality of customers;
identifying a target time period after the base training time period;
determining an attrition status of each of the first plurality of customers based on account activities of the one or more accounts related to each customer in connection with the target time period;
classifying the first plurality of customers based on the attrition status of each of the first plurality of customers in connection with the target time period; and
generating a classification rule based on the customer data for each of the first plurality of customers related to the base training time period, and a result of the classifying step.

12. The method of claim 11 further comprising the steps of:
identifying a prediction time period;
identifying a base time period prior to the prediction time period;
accessing customer data for each of the second plurality of accounts in connection with the base time period, wherein the customer data includes account information of one or more accounts associated with each of the second plurality of customers; and
classifying the second plurality of customers by applying the classification rule to the accessed customer data for each of the second plurality of customers in connection with the base time period.

13. The method of claim 12 further comprising a step of generating an attrition prediction report based on a result of the classifying step, wherein the report includes a prediction of an attrition status for each of the second plurality of customers.

14. The method of claim 13 further comprising a step of generating a warning message for at least one of the second plurality of customers that has a predicted attrition status indicating that the customer will become an attrition customer in the prediction time period.

15. The method of claim 13 further comprising the steps of:
accessing profitability data of each of the second plurality of customers or each of the at least one customer that will become an attrition customer;
comparing the profitability data of each of the second plurality of customers or each of the at least one customer that will become an attrition customer with a predetermined profitability threshold; and
generating a profitability status for each of the second plurality of customers or each of the at least one customer that will become an attrition customer, based on a result of the comparing step.

16. The method of claim 15 further comprising a step of classifying the second plurality of customers based on the predicted attrition status and the profitability status of each of the second plurality of customers.

17. The method of claim 16 further comprising a step of identifying at least one customer that both has a predicted attrition status indicating that the customer will become an attrition customer in the prediction time period, and a profitability status exceeding the predetermined profitability threshold.

18. The method of claim 12, wherein the length of the base training time period is substantially equal to the length of the base time period.

19. The method of 11, wherein the customer data includes at least one of: total assets of one or more accounts associated with a customer, total trade number in connection with one or more accounts associated with a customer, and total revenue associated with one or more accounts associated with a customer.

20. The method of 12, wherein the customer data for each of the second plurality of customers in connection with the base time period includes at least one of: total assets of one or more accounts associated with a customer, total trade number in connection with one or more accounts associated with a customer, and total revenue associated with one or more accounts associated with a customer.

21. A method for predicting attrition accounts comprising the steps of:
defining a target time period;
determining an attrition status of each of a first plurality of accounts in connection with the target time period;
classifying the first plurality of accounts based on the attrition status of each of the first plurality of accounts in connection with the target time period;
selecting a base training time period prior to the target time period;
accessing account information for each of the first plurality of accounts related to the base training time period; and
generating a classification rule based on the account information for each of the first plurality of accounts related to the base training time period, and a result of the classifying step.

22. The method of claim 21 further comprising the steps of:
identifying a prediction time period;
identifying a base time period prior to the prediction time period;
accessing account information for each of the second plurality of accounts in connection with the base time period; and
classifying the second plurality of accounts by applying the classification rule to the accessed account information for each of the second plurality of accounts in connection with the base time period.

23. The method of claim 22 further comprising a step of generating an attrition prediction report based on a result of the classifying step, wherein the report includes a prediction of an attrition status for each of the second plurality of accounts.

24. The method of claim 23 further comprising a step of generating a warning message for at least one of the second plurality of accounts that has a predicted attrition status indicating that the account will become an attrition account in the prediction time period.

25. The method of claim 23 further comprising the steps of:
accessing profitability data of each of the second plurality of accounts or each of the at least one account that will become an attrition account;
comparing the profitability data of each of the second plurality of accounts or each of the at least one account that will become an attrition account with a predetermined profitability threshold; and
generating a profitability status for each of the second plurality of accounts or each of the at least one account that will become an attrition account, based on a result of the comparing step.

26. The method of claim 25 further comprising a step of classifying the second plurality of accounts based on the predicted attrition status and the profitability status of each of the second plurality of accounts.

27. The method of claim 26 further comprising a step of identifying at least one account that both has a predicted attrition status indicating that the account will become an attrition account in the prediction time period, and a profitability status exceeding the predetermined profitability threshold.

28. The method of claim 22, wherein the length of the base training time period is substantially equal to the length of the base time period.

29. The method of 21, wherein the account information includes at least one of: total assets of the account, total trade number in connection with the account, and total revenue associated with the account.

30. The method of 22, wherein the account information for each of the second plurality of accounts in connection with the base time period includes at least one of: total assets of the account, total trade number in connection with the account, and total revenue associated with the account.

31. The method of claim 21, wherein the base time period is selected based on the attrition status of each account.

32. The method of claim 31, wherein:
for an attrition account, the base time period is selected to be a predetermined time period prior to the account becomes attrited; and
for a non-attrition account, the base time period is selected to be the predetermined time period prior to the target time period.

33. A method for predicting attrition customers comprising the steps of:
defining a target time period;
determining an attrition status of each of a first plurality of customers in connection with the target time period based on account activities of one or more accounts related to each customer in connection with the target time period;
classifying the first plurality of customers based on the attrition status of each of the first plurality of customers in connection with the target time period;
selecting a base training time period prior to the target time period;
accessing customer data for each of the first plurality of customers related to the base training time period, wherein the customer data includes account information of one or more accounts associated with each of the first plurality of customers; and
generating a classification rule based on the customer data for each of the first plurality of customers related to the base training time period, and a result of the classifying step.

34. The method of claim 33 further comprising the steps of:
identifying a prediction time period;
identifying a base time period prior to the prediction time period;
accessing customer data for each of the second plurality of accounts in connection with the base time period, wherein the customer data includes account information of one or more accounts associated with each of the second plurality of customers; and
classifying the second plurality of customers by applying the classification rule to the accessed customer data for each of the second plurality of customers in connection with the base time period.

35. The method of claim 34 further comprising a step of generating an attrition prediction report based on a result of the classifying step, wherein the report includes a prediction of an attrition status for each of the second plurality of customers.

36. The method of claim 35 further comprising a step of generating a warning message for at least one of the second plurality of customers that has a predicted attrition status indicating that the customer will become an attrition customer in the prediction time period.

37. The method of claim 35 further comprising the steps of:
accessing profitability data of each of the second plurality of customers;
comparing the profitability data of each of the second plurality of customers with a predetermined profitability threshold; and
generating a profitability status for each of the second plurality of customers based on a result of the comparing step.

38. The method of claim 37 further comprising a step of classifying the second plurality of customers based on the predicted attrition status and the profitability status of each of the second plurality of customers.

39. The method of claim 38 further comprising a step of identifying at least one customer that both has a predicted attrition status indicating that the customer will become an attrition customer in the prediction time period, and a profitability status exceeding the predetermined profitability threshold.

40. The method of claim 34, wherein the length of the base training time period is substantially equal to the length of the base time period.

41. The method of 33, wherein the customer data includes at least one of: total assets of one or more accounts associated with a customer, total trade number in connection with one or more accounts associated with a customer, and total revenue associated with one or more accounts associated with a customer.

42. The method of 34, wherein the customer data for each of the second plurality of customers in connection with the base time period includes at least one of: total assets of one or more accounts associated with a customer, total trade number in connection with one or more accounts associated with a customer, and total revenue associated with one or more accounts associated with a customer.

43. The method of claim 33, wherein the base time period is selected based on the attrition status of each customer.

44. The method of claim 43, wherein:
for an attrition customer, the base time period is selected to be a predetermined time period prior to the customer becomes attrited; and
for a non-attrition customer, the base time period is selected to be the predetermined time period prior to the target time period.

45. A data processing system for calculating profitability of an account, comprising:
a processor for processing data; and
a data storage device coupled to the processor;
wherein the data storage device bearing instructions to cause the data processing system to perform the steps as in the method of claim 1.

46. A data processing system for calculating profitability of an account, comprising:
a processor for processing data; and
a data storage device coupled to the processor;
wherein the data storage device bearing instructions to cause the data processing system to perform the steps as in the method of claim 11.

47. A data processing system for calculating profitability of an account, comprising:
a processor for processing data; and
a data storage device coupled to the processor;
wherein the data storage device bearing instructions to cause the data processing system to perform the steps as in the method of claim 21.

48. A data processing system for calculating profitability of an account, comprising:
a processor for processing data; and
a data storage device coupled to the processor;
wherein the data storage device bearing instructions to cause the data processing system to perform the steps as in the method of claim 33.

49. A program comprising instructions, which may be embodied in a machine-readable medium, for controlling a data processing system to calculate profitability of an account, the instructions upon execution by the data processing system causing the data processing system to perform the steps as in the method of claim 1.

50. A program comprising instructions, which may be embodied in a machine-readable medium, for controlling a data processing system to calculate profitability of an account, the instructions upon execution by the data processing system causing the data processing system to perform the steps as in the method of claim 11.

51. A program comprising instructions, which may be embodied in a machine-readable medium, for controlling a data processing system to calculate profitability of an account, the instructions upon execution by the data processing system causing the data processing system to perform the steps as in the method of claim 21.

52. A program comprising instructions, which may be embodied in a machine-readable medium, for controlling a data processing system to calculate profitability of an account, the instructions upon execution by the data processing system causing the data processing system to perform the steps as in the method of claim 33.
